(19) United States
(12) Patent Application Publication
(10) Pub. No.: US 2012/0106434 A1
(43) Pub. Date: May 3, 2012

(54) MEMS CMOS VIBRATING ANTENNA AND APPLICATIONS THEREOF

(75) Inventors: Josep Montanya Silvestre, Rubi (ES); Juan Jose Valle Fraga, Burela (ES)

(73) Assignee: Baolab Microsystems SL, Terrassa (ES)

(21) Appl. No.: 13/188,827

(22) Filed: Jul. 22, 2011

Related U.S. Application Data
(60) Provisional application No. 61/400,209, filed on Jul. 23, 2010.

(51) Int. Cl. H04B 7/14

(52) U.S. Cl. 370/315

(57) ABSTRACT

The systems and methods described herein address deficiencies in the prior art by enabling spatial multiplexing in cellular and/or wireless networks to overcome capacity limitations. In one embodiment, the limitations are overcome by forming a spatially multiplexed network of portable communications devices having MEMS-based vibrating antennas. Other suitable applications of vibrating antennas are also described.

### CROSS-REFERENCE TO RELATED APPLICATIONS

This Application claims the benefit of U.S. Provisional Patent Application Ser. No. 61/400,209 filed on Jul. 23, 2010, which is incorporated by reference herein in its entirety.

### BACKGROUND

Typical cellular networks are limited in their capacity to handle multiple users. Once the capacity of a cellular network base station is reached, users are unable to make calls until capacity is freed up by other users. Some of these issues are partially alleviated by configuring the base stations to utilize multiplexing schemes, such as frequency multiplexing, time multiplexing, or code multiplexing. However, even with the application of multiplexing schemes, the capacity is limited. This means that once a given number of users is reached, the electromagnetic spectrum associated with the base station becomes saturated and no more users can be placed there. This may especially be an issue in crowded urban areas with users outnumbering the capacity of available cellular networks. Accordingly, there is a need for systems and methods that can overcome the saturation of the electromagnetic spectrum in cellular and/or wireless networks.

### SUMMARY

The systems and methods described herein address deficiencies in the prior art by enabling spatial multiplexing in cellular and/or wireless networks to overcome spectrum limitations. In one embodiment, the limitations are overcome by forming a spatially multiplexed network of portable communications devices having micro-electro-mechanical systems (MEMS)-based vibrating antennas.

Spatial multiplexing is a transmission technique in multiple-input multiple-output wireless communication to transmit independent and separately encoded data signals from each of a plurality of transmit antennas. This technique reuses, or multiplexes, the space dimension such that the space dimension is utilized more than once. For example, if a transmitter is equipped with N antennas and a receiver is equipped with N antennas, N signals can be transmitted in parallel, ideally leading to an N-fold increase in channel capacity of the transmitter/receiver system. In the case of a spatially multiplexed network, each network device includes multiple transmission/reception capability and is placed in the network such that the device is within the vicinity of at least one other device. Each device scans for other devices in its vicinity and sets up communications channels with the devices found during the scan. Any device on the network can communicate with another device on the network via these established communications channels. While typical cellular networks are limited to a maximum number of devices, a spatially multiplexed network does not suffer from such a limitation. A spatially multiplexed network instead acquires more capacity as devices are added to the network. In one embodiment, the channel capacity increases proportional to the square of number of users.

A spatially multiplexed network may be formed from portable communications devices that each have one or more MEMS-based vibrating antennas. MEMS-based solutions may offer reduction in die space, insertion loss, consume minimal power during operation, and provide low signal distortion. MEMS technology may be used to build a vibrating antenna that changes its shape over a period of time in two ways. The first way includes switching a set of fixed antennas or antenna parts via MEMS switches, e.g., solid state switches or any other suitable devices. The second way includes mechanically moving an antenna built using MEMS technology. The movement is typically accomplished via electrostatic forces, although the forces may be piezoelectric, magnetic, or thermal in nature. The moving structure interacts with electromagnetic waves to generate an output signal that may be sensed. However, MEMS technology is only one type of process to build vibrating antennas. The manufacture process of vibrating antennas need not be limited to MEMS technology. For example, vibrating antennas may be implemented as carbon nanotube-based nano-electro-mechanical systems (NEMS) devices. In another example, vibrating antennas may be fabricated using a CMOS MEMS-based process described in commonly-owned U.S. Patent Application Publication No. 2010/0295138, entitled “Methods and Systems for Fabrication of MEMS CMOS Devices”, and hereby incorporated by reference in its entirety.

In one aspect, the systems and methods described herein related to a communications system. The communications system includes portable communications devices that form a spatially multiplexed network. Each communications device includes a vibrating antenna that is configured to receive and transmit in multiple directions. The communications system further includes a first communications device from the communications devices that is configured to transmit a signal to the communications devices. Transmitting the signal may include initiating a movement of a first vibrating antenna of the first communications device. The communications system further includes a second communications device from the communications devices that is configured to receive the signal and retransmit the signal to the communications devices. Receiving the signal may include allowing a movement of a second vibrating antenna of the second communications device in response to the signal.

In some embodiments, the vibrating antenna in each communications device of the communications system includes a MEMS-based vibrating antenna, a NEMS-based vibrating antenna, and/or a CMOS MEMS-based vibrating antenna. In some embodiments, the vibrating antenna in each communications device of the communications system is a flashing antenna, a faraday antenna, a lorentz antenna, a linear rotating antenna, or a synchronized rotating antenna. In some embodiments, the vibrating antenna in each communications device of the communications system is composed of silicon, carbon nano-tubes, and/or graphene.

In some embodiments, the communications system further includes a base station that is configured to receive the signal from one or more of the communications devices, and send a second signal to one or more of the communications devices. In some embodiments, the spatially multiplexed network that is a telecommunications network and at least one of the communications devices is a mobile telephone. In some embodiments, a capacity available to each communication device is proportional to the number of communications devices forming the network.

In some embodiments, the movement of the first vibrating antenna of the first communications device is initiated at a frequency corresponding to an open or unlicensed wireless frequency. In some embodiments, the movement of the first vibrating antenna of the first communications device is initiated at about 60 GHz or a higher frequency. In some embodiments, the communications devices in the communications system are determined to be within a vicinity of the first communications device.

In another aspect, the systems and methods described herein related to method for providing a communications system. The method includes providing portable communications devices that form a spatially multiplexed network. Each communications device includes a vibrating antenna that is configured to receive and transmit in multiple directions. The method further includes transmitting, from a first communications device of the communications devices, a signal to the communications devices. Transmitting the signal may include initiating a movement of a first vibrating antenna of the first communications device. The method further includes receiving the signal at a second communications device of the communications devices. Receiving the signal may include allowing a movement of a second vibrating antenna of the second communications device in response to the signal. The method further includes retransmitting, form the second communications device, the signal to the communications devices.

In yet another aspect, the systems and methods described herein related to an electromagnetic signal emitting and/or receiving device having a minimum operational bandwidth or bandwidth frequency. The device includes an antenna for generating an output signal. The antenna is oriented in a first direction. The antenna is configured to be periodically deformed, periodically tilted, and/or periodically oriented in a second direction different from the first direction according to a first periodic movement that has a first frequency higher than the minimum operational bandwidth. In some embodiments, the antenna is oriented in a first direction, and the antenna is further configured to be periodically oriented in a second direction different from the first direction according to the first periodic movement. In some embodiments, the antenna is further configured to be periodically rotated according to the first periodic movement. In some embodiments, the antenna is further configured to be periodically switched according to the first periodic movement.

### BRIEF DESCRIPTION OF THE DRAWINGS

Other advantages and characteristics of the systems and methods described herein may be appreciated from the following description, which provides a non-limiting description of illustrative embodiments, with reference to the accompanying drawings, in which:

FIG. 1 depicts a diagrammatic view of a typical cellular network;

FIG. 2A depicts a diagrammatic view of a spatially multiplexed network formed from a plurality of portable communications devices, according to an illustrative embodiment of the invention;

FIG. 2B is a flow diagram depicting operation of the spatially multiplexed network of FIG. 2A as a signal is propagated from a source device to a target device via the spatially multiplexed network, according to an illustrative embodiment of the invention;

FIG. 3A is a diagrammatic view of a portable communications device having a plurality of integrated vibrating antennas, according to an illustrative embodiment of the invention;

FIG. 3B is a diagrammatic view of a portable communications device having an integrated vibrating antenna, according to an illustrative embodiment of the invention;

FIG. 4A depicts a diagrammatic view of a Flashing antenna in an inactive state, according to an illustrative embodiment of the invention;

FIG. 4B depicts a diagrammatic view of a Flashing antenna in an actuated state, according to an illustrative embodiment of the invention;

FIG. 4C depicts a diagrammatic view of a Flashing antenna in an actuated state, according to another illustrative embodiment of the invention;

FIG. 5A depicts a diagrammatic view of a Faraday antenna in an inactive state, according to an illustrative embodiment of the invention;

FIG. 5B depicts a diagrammatic view of a Faraday antenna in an actuated state, according to an illustrative embodiment of the invention;

FIG. 5C depicts a perspective view of a Faraday antenna in an inactive state, according to another illustrative embodiment of the invention;

FIG. 5D depicts a perspective view of a Faraday antenna in an inactive state, according to yet another illustrative embodiment of the invention;

FIG. 6A depicts a diagrammatic view of a Lorentz antenna in an inactive state, according to an illustrative embodiment of the invention;

FIG. 6B depicts a diagrammatic view of a Lorentz antenna in an actuated state, according to an illustrative embodiment of the invention;

FIG. 6C depicts a perspective view of a Lorentz antenna in an inactive state, according to another illustrative embodiment of the invention;

FIG. 6D depicts a perspective view of a series of Lorentz antennas in an inactive state, according to an illustrative embodiment of the invention;

FIG. 7A depicts a diagrammatic view of a linear rotating antenna in an inactive state, according to an illustrative embodiment of the invention;

FIG. 7B depicts a diagrammatic view of a linear rotating antenna in an actuated state, according to an illustrative embodiment of the invention;

FIG. 8A depicts a cross-section after a first set of process flow steps for fabricating a vibrating antenna, according to an illustrative embodiment of the invention;

FIG. 8B depicts a cross-section after a second set of process flow steps for fabricating a vibrating antenna, according to an illustrative embodiment of the invention;

FIG. 8C depicts a cross-section after a third set of process flow steps for fabricating a vibrating antenna, according to an illustrative embodiment of the invention.

### DETAILED DESCRIPTION OF EMBODIMENTS

To provide an overall understanding of the systems and methods described herein, certain illustrative embodiments will now be described. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof.

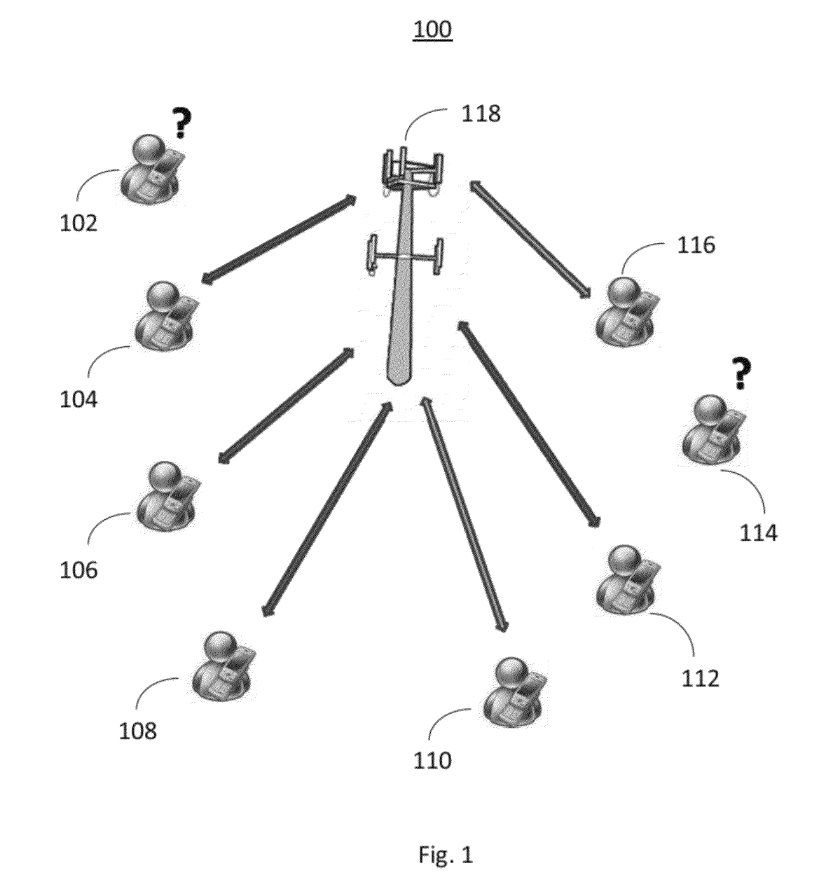

FIG. 1 depicts a diagrammatic view of a typical cellular network 100. A cellular network includes at least one fixed-location transceiver or base station 118. When joined together these base stations provide radio coverage over a wide geographic area. The base stations are further configured to utilize multiplexing schemes, such as frequency multiplexing, time multiplexing, or code multiplexing. This enables a large number of portable transceivers or portable communications devices (e.g., mobile telephones, pagers) to communicate with each other and with fixed transceivers and telephones anywhere in the network via base stations 118. Though a cellular network with base stations 118 can accommodate multiple devices, base station 118 is limited in the number of devices that it can accommodate and once that number is reached, the capacity becomes saturated and no more users can be placed on the network. This is illustrated in FIG. 1 where device 102 is unable to connect to device 114 because the capacity of base station 118 has been saturated. Further details for this example are provided below.

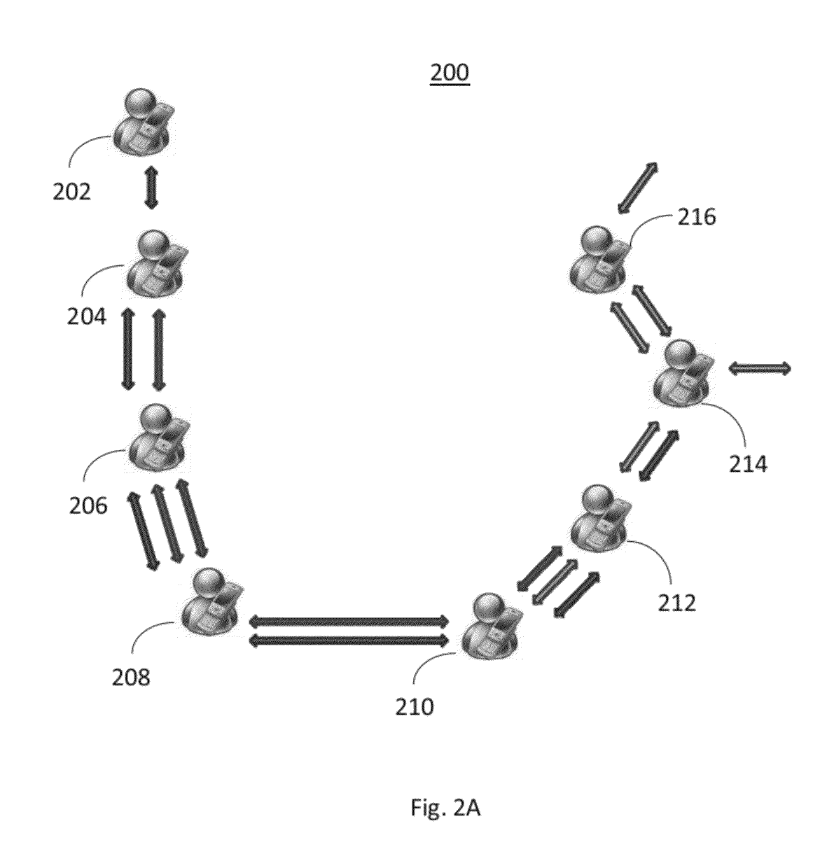

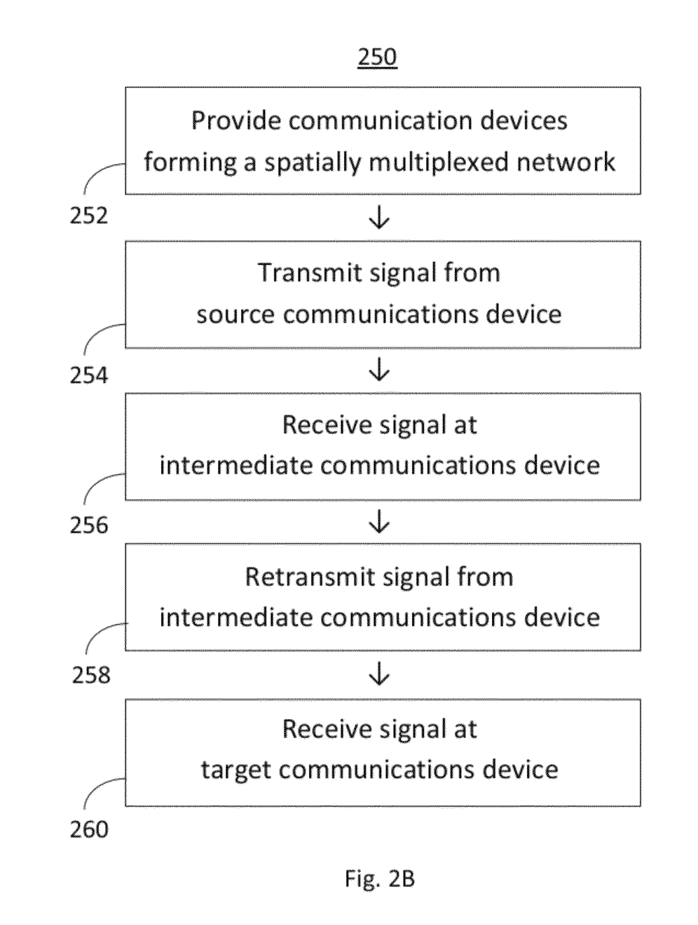

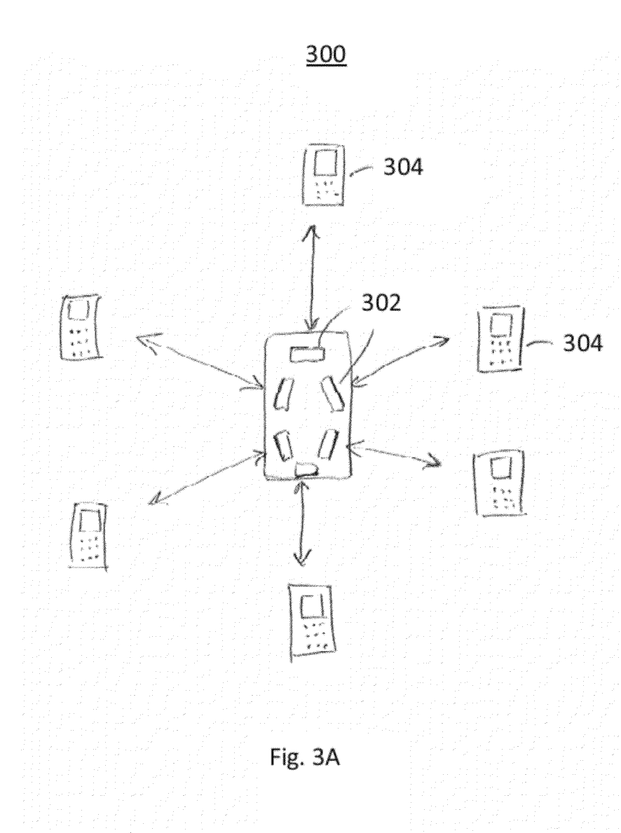

In the embodiment shown in FIG. 1, device 104 is connected to device 112 via base station 118, device 106 is connected to device 108 via base station 118, and device 110 is connected to device 116 via base station 118. Once these connections are established, the capacity of base station 118 is saturated and attempts to establish connections by other devices (e.g., devices 102 and 114) are rejected. Consequently, device 102 is unable to join the network and cannot connect to device 114 or vice versa. One way to overcome this limitation is to eliminate base station 118 from the network, and instead form a spatially multiplexed network from the portable communications devices 102-116. This advantageous approach is further illustrated with respect to FIGS. 2A and 3 below.

FIG. 2A depicts a diagrammatic view of a spatially multiplexed network 200 formed from a plurality of portable communications devices 202-216. Spatial multiplexing is a transmission technique in multiple-input multiple-output wireless communication to transmit independent and separately encoded data signals from multiple transmit antennas. In the case of a spatially multiplexed network, each device is capable of multiple signal transmission/reception and is placed in the network such that the device is within the vicinity of at least one other device. Each device scans for other devices in its vicinity and sets up communications channels with the devices found during the scan. In one embodiment, each device periodically scans for devices added or removed from the network and reestablishes communications channels in order to form a dynamically configurable network. Any device on the network can communicate with another device on the network via these established communications channels. While typical cellular networks are limited to a maximum number of devices, a spatially multiplexed network does not suffer from such a limitation. A spatially multiplexed network instead acquires more capacity as devices are added to the network. In other words, the more number of devices in the network, the better it works for everybody. The channel capacity increases proportional to the number of devices in the network. In one embodiment, the channel capacity increases proportional to the square of number of devices.

In the embodiment shown in FIG. 2A, device 204 is connected to device 212, device 206 is connected to device 208, and device 210 is connected to device 216. These connections are similar to the connections shown in FIG. 1. However, instead of being connected via a base station, the devices are connected via the spatially multiplexed network formed from devices 202-216. For example, device 204 is connected to device 212 via devices 204, 206, 208, and 210. In another example, device 206 is connected to device 208 directly. In yet another example, device 210 is connected to device 216 via devices 212 and 214. Furthermore, devices 202 and 214 are also connected via devices 204, 206, 208, 210, and 212. As discussed above, the spatially multiplexed network acquires more capacity with an increase in number of devices, and therefore, devices 202 and 214 are able to connect with each other without suffering from the capacity issue described with respect to FIG. 1. Opposite to the network of FIG. 1 where addition of devices translates to diminished capacity for each device, the spatially multiplexed network of FIG. 2A provides increased capacity for each device as more devices are added to the network.

Cellular network providers typically buy frequency bands for their cellular networks. The frequency bands are utilized by base stations to transmit signals to portable communications devices in the network. For example, the base station may transmit a signal to a first device on a first frequency in the allocated frequency band, while transmitting a signal to a second device on a second frequency in the allocated frequency band. However, once the capacity of the base station is reached, no more devices can connect to the base station. This issue arises because the signals are sent in all directions irrespective of the location of the target device. However, in a spatially multiplexed network, signals are only sent in the direction of the target device. As discussed above, each device in a spatially multiplexed network periodically scans for other devices in its vicinity and establishes communications channels with the devices found. The signals sent from a source device in the network to a target device are highly directive. This is accomplished with the use of vibrating antennas, further details for which are provided with respect to FIGS. 3A and 3B below. Due to the highly directive nature of the vibrating antenna signals, all users in the spatially multiplexed network may use the same frequency to establish communications channels and send signals to each other. Therefore, the proposed spatially multiplexed network may eliminate saturation problems observed in electromagnetic spectrums associated with today's cellular networks.

In one embodiment, the frequency for establishing communications channels is chosen from an unlicensed or open frequency band, e.g., 60 GHz. In order to establish a spatially multiplexed network, a critical mass of users may be necessary, along with vibrating antennas integrated in network devices that can establish communications channels in multiple directions. This critical mass may be sustained by ensuring that each network device has at least one other device within its range. In the case of a 60 GHz frequency band, the range of each device may vary from about 1 m to about 100 m. In embodiments where the critical mass has not yet been reached, conventional base stations may be deployed to supplement any gaps in coverage of the spatially multiplexed network. Therefore, the devices may employ conventional cellular technology when a device for forming a spatially multiplexed communications channel is unavailable. This approach may be considered to be a disruptive change in current mobile telephony practices. Chip manufacturers may fabricate devices with integrated vibrating antennas for conventional cellular networks. On acquiring critical mass, the manufacturers may activate the integrated vibrating antennas and consequently also function as telecom operators. They may be further motivated to venture into the telecom operator field given the opportunity to use open or unlicensed wireless frequencies and to avoid costs associated with purchasing licenses for frequency bands. This innovative spatially multiplexed network is enabled by integrating vibrating antennas in portable communications devices, details for which are provided with respect to FIGS. 3A and 3B.

To summarize the operation of a spatially multiplexed network as described with reference to FIG. 2A, FIG. 2B is a flow diagram 250 depicting operation of the spatially multiplexed network. In particular, FIG. 2B depicts operation of the spatially multiplexed network as a signal is propagated from a source device to a target device via the spatially multiplexed network. A number of portable communications devices are placed to form a network such that each device is within vicinity of at least one other device (step 252). Each device may periodically scan for other devices and establish communications channels as devices are added or removed from the network. The source device transmits a signal for the target device to the network (step 254). Another (intermediate) device receives the signal from the source device and retransmits the signal to another device in the network (steps 256, 258). Steps 256 and 258 may be repeated until the signal is received at the target device (step 260).

In some embodiments, in the absence of an available intermediate device within the vicinity of the source device, a base station receives the signal from the source device and retransmits the signal to another device in the network. The base station may be a typical cellular station or any other suitable type of communications station. For example, the source device may initiate a phone call that is transmitted to the target device via a cellular station. In some embodiments, an intermediate device or base station is not used between the target and source devices. For example, an intermediate device may not be used when the target device is within vicinity of the source device. In such a case, the signal is received at the target device directly from the source device (e.g., devices 206 and 208 in FIG. 2A).

A spatially multiplexed network, e.g., described with respect to FIGS. 2A and 2B above, may be formed from portable communications devices that each have one or more MEMS-based vibrating antennas. MEMS-based solutions may offer reduction in die space, insertion loss, consume minimal power during operation, and provide low signal distortion. MEMS technology may be used to build a vibrating antenna that changes its shape over a period of time in two ways. The first way includes switching a set of fixed antennas. Each antenna is pointed in a different direction and the antennas receive/transmit signals in multiple directions via switch multiplexing. The second way includes mechanically moving an antenna built using MEMS technology. The movement is typically accomplished via electrostatic forces, although the forces may be piezoelectric, magnetic, or thermal in nature. The moving structure interacts with electromagnetic waves to generate an output signal that may be sensed. However, MEMS technology is only one type of process to build vibrating antennas. The manufacture process of vibrating antennas need not be limited to MEMS technology. For example, vibrating antennas may be implemented as carbon nanotube-based nano-electro-mechanical systems (NEMS) devices. In another example, vibrating antennas may be fabricated using a CMOS MEMS-based process described in commonly-owned U.S. Patent Application Publication No. 2010/0295138, entitled “Methods and Systems for Fabrication of MEMS CMOS Devices”.

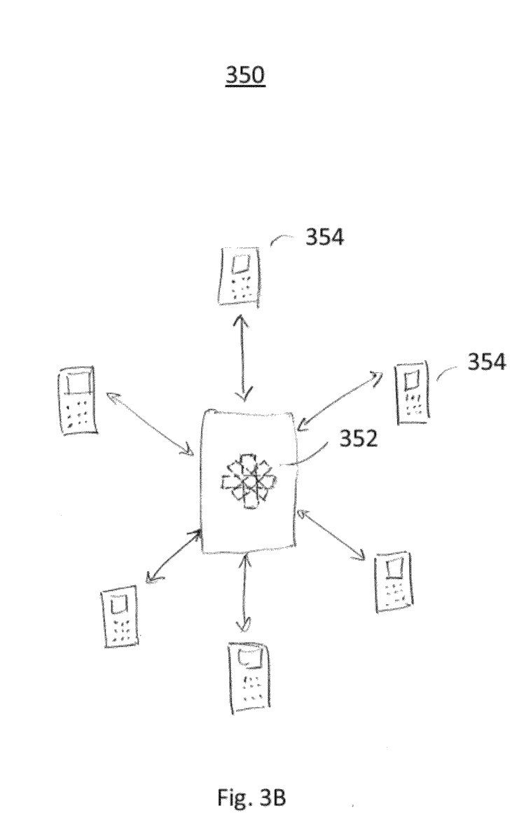

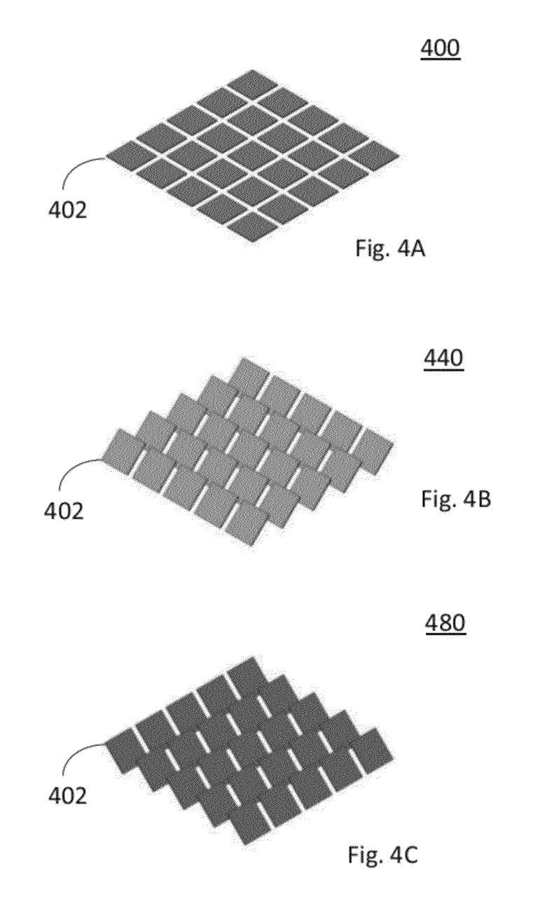

FIG. 3A is a diagrammatic view of a portable communications device 300 having integrated vibrating antennas 302. This embodiment corresponds to the first approach described above where a set of fixed antennas pointing in different directions are multiplexed to receive/transmit signals in multiple directions. Each antenna 302 is directed towards a particular direction and may establish communications channels with a device 304 in that direction. Therefore, device 300 may establish communications channels with each of devices 304 via antennas 302. Though this embodiment shows six antennas, a large number of such antennas may be employed for establishing communications channels with other devices in the network. For example, about 100 or more such antennas may be employed. In another embodiment, about 1000 or more such antennas may be employed. Even such a large number of vibrating antennas may be advantageously fabricated in a small space via MEMS technology, and thus, be easily deployed in portable communications devices or base stations alike. Examples of types of vibrating antennas are described with respect to FIGS. 4A-7B.

FIG. 3B is a diagrammatic view of a portable communications device 350 having an integrated vibrating antenna 352. This embodiment corresponds to the second approach described above where a single vibrating antenna is mechanically moved to receive and transmit signals in a plurality of directions. Antenna 352 is moved via electrostatic actuation. In alternative embodiments, antenna 352 is moved via piezoelectric actuation, magnetic actuation, thermal actuation, or any other suitable type of forced actuation. Antenna 352 is moved such that it can receive transmit/receive signals in multiple directions. For example, in the embodiment shown in FIG. 3B, antenna 352 is moved through six different directions. This allows device 350 to establish communications channels with each of devices 354 via antenna 352. In one embodiment, the vibrating frequency of the antenna is desired to be higher than the bandwidth frequency of the incoming signals. This way there is minimal to zero aliasing which would otherwise result from the received signal being modulated at the same vibrating frequency by the antennas. Having aliasing may lead to a signal received from a particular direction being lost and/or indistinguishable from signals coming from other directions. An example of a signal being lost is described further below.

As antenna 352 moves in time towards a certain direction, the gain of the antenna in that direction increases with time. Similarly, as antenna 352 moves away in time from a certain direction, the gain of the antenna in that direction decreases with time. A signal received from a certain direction at antenna 352 is modulated by the gain associated with that direction at that point in time. If the gain is too low, the signal may be attenuated too much and may be lost. Therefore, in order to ensure that none of the received signals are modulated by such a low gain, i.e., attenuated close to zero, the vibrating frequency of the antenna is desired to be higher than the bandwidth frequency of the incoming signals. In other words, to ensure a received signal is not lost, the vibrating frequency of the antenna needs to be higher than the bandwidth frequency of the received signal. Certain embodiments of vibrating antennas may be found described in commonly-owned International PCT Patent Application Publication No. WO2005/112190, entitled “Electromagnetic Signal Emitting and/or Receiving Device and Corresponding Integrated circuit”, which is hereby incorporated by reference in its entirety. Embodiments of different types of vibrating antennas are also described with respect to FIGS. 4A-7B below.

FIG. 4A depicts a diagrammatic view of a Flashing antenna in an inactive state 400. In the embodiment shown, the Flashing antenna includes a number of interconnected elements 402. Elements 402 behave as one antenna but are individually actuated and are capable of moving independently of each other. In order to receive a signal, elements 402 are periodically actuated, either independently or together, to a fixed set of positions. The actuation may be due to electrostatic, magnetic, piezoelectric, or thermal forces. FIGS. 4B and 4C depict embodiments 440 and 480, respectively, of elements 402 in an actuated state. The signal received by elements 402 in each position is stored along with a time value for when the signal is received. The collected values are then provided to a digital signal processor (DSP) to calculate the incoming signal received at elements 402 as they are actuated through the fixed set of positions. In one embodiment, the Flashing antenna is implemented as a single moving element that is similarly periodically oriented in multiple positions and data is collected and processed by a DSP, a field programmable gate array (FPGA), an analog circuit, or any other suitable electronic means, to calculate the incoming signal received at elements 402 as they are actuated through the fixed set of positions. The incoming signal can be calculated by determining the electrical field strengths E (Ωᵤ), in each direction Ωᵤ, according to the following set of equations:

$${v}_{i} ( t ) = {\sum }_{u = 1}^{N} {KD}^{1 / 2} ( {Ω}_{u} , t ) E ( {Ω}_{u} ) {\hat{e}}_{r} ( {Ω}_{u} ) {\hat{e}}_{a} ( {Ω}_{u} , t ) \\ [ \begin{matrix}{KD}^{1 / 2} ( \begin{matrix}{Ω}_{1} , \\ {t}_{1}\end{matrix} ) {\hat{e}}_{a} ( \begin{matrix}{Ω}_{1} , \\ {t}_{1}\end{matrix} ) & {KD}^{1 / 2} ( \begin{matrix}{Ω}_{2} , \\ {t}_{1}\end{matrix} ) {\hat{e}}_{a} ( \begin{matrix}{Ω}_{2} , \\ {t}_{1}\end{matrix} ) & … & {KD}^{1 / 2} ( \begin{matrix}{Ω}_{n} , \\ {t}_{1}\end{matrix} ) {\hat{e}}_{a} ( \begin{matrix}{Ω}_{n} , \\ {t}_{1}\end{matrix} ) \\ {KD}^{1 / 2} ( {Ω}_{1} , {t}_{2} ) {\hat{e}}_{a} ( {Ω}_{1} , {t}_{2} ) & & & \\ … & & & \\ {KD}^{1 / 2} ( {Ω}_{1} , {t}_{n} ) {\hat{e}}_{a} ( {Ω}_{1} , {t}_{n} ) & & & {KD}^{1 / 2} ( \begin{matrix}{Ω}_{n} , \\ {t}_{n}\end{matrix} ) {\hat{e}}_{a} ( \begin{matrix}{Ω}_{n} , \\ {t}_{n}\end{matrix} )\end{matrix} ] [ \begin{matrix}\begin{matrix}E ( {Ω}_{1} ) \\ {\hat{e}}_{r} ( {Ω}_{1} )\end{matrix} \\ … \\ \\ \begin{matrix}E ( {Ω}_{n} ) \\ {\hat{e}}_{r} ( {Ω}_{n} )\end{matrix}\end{matrix} ] = [ \begin{matrix}{v}_{i} ( {t}_{1} ) \\ … \\ \\ {v}_{i} ( {t}_{2 N} )\end{matrix} ]$$

where vᵢ(tᵤ) is the signal received at each time value (corresponding to each antenna position), êᵣ(Ωᵤ) and êₐ(Ωᵤ) are the polarization vectors for the received signal and the antenna, respectively, in each direction Ωᵤ, D(Ωᵤ,tᵤ) is the directivity in each direction and time interval (or antenna position/shape), and E(Ωᵤ) are the electrical field strengths, in each direction Ωᵤ.

Flashing antennas can be implemented in a compact size, e.g., using MEMS-based technology, and can provide high resolution in applications having high carrier frequencies and low information bandwidth. In addition to spatially multiplexed networks, Flashing antennas may be well suited in the field of automotive radar systems. In one embodiment, an automotive radar system receives a new frame every 40 ms, i.e., the system has a low information bandwidth of 25 Hz. Furthermore, the system has high carrier frequencies of 24 GHz and/or 79 GHz. The Flashing antenna elements are continuously moved to a set of fixed positions every new frame, i.e., 40 ms, and the signal received by each element in each position is stored along with a time value for when the signal is received. The collected values are then provided to a DSP to calculate the incoming signal. Such a Flashing antenna can serve as a powerful sensor with high resolution in automotive radar systems. In one embodiment, two Flashing antennas are used in a bistatic approach, one antenna each for reception and transmission, respectively. In an alternative embodiment, only one Flashing antenna is used in a monostatic approach, reusing the same antenna for transmission as well as reception. Though the monostatic approach may add complexity to the control circuitry for the Flashing antenna compared to the bistatic approach, the monostatic approach advantageously reduces the chip area by 50%. In yet another alternative embodiment, one Flashing antenna may be used for reception only, depending on the automotive radar application. This embodiment provides an advantageous 50% reduction in chip area compared to the bistatic approach, and reduces power consumption compared to both the bistatic and monostatic approaches. Another application for the Flashing antenna may be in the field of high resolution scanners, such as for security scanners at airports and public buildings, medical scanners, and anti-shoplifting systems.

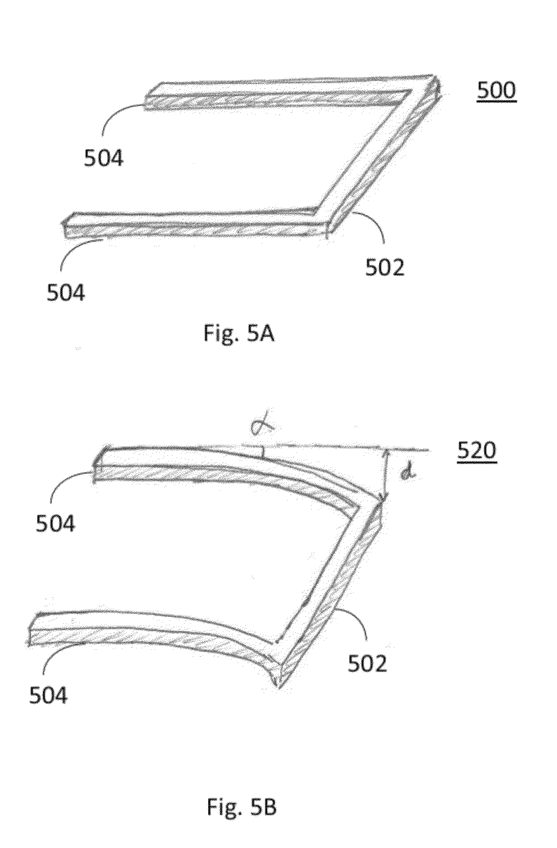

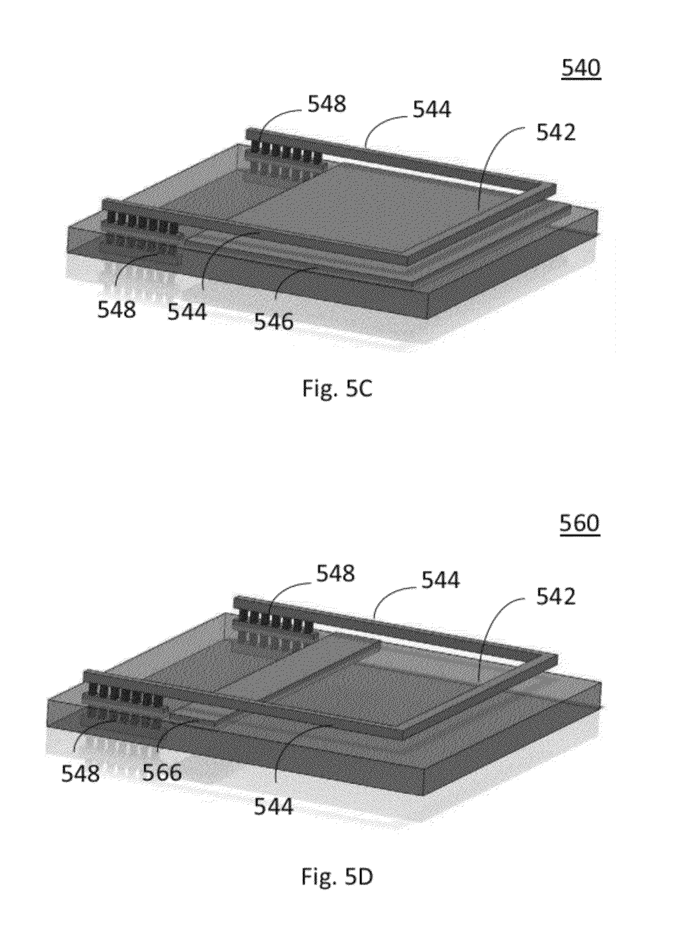

FIG. 5A depicts a diagrammatic view of a Faraday antenna in an inactive state 500. In the embodiment shown, the Faraday antenna includes a loop formed from cantilevers 504 joined together via union element 502. The antenna loop is electrostatically actuated at a high vibrating frequency to periodically deform or bend cantilevers 504 resulting in a periodic change of the area orientation of the loop. The actuation may alternatively be due to magnetic, piezoelectric, or thermal forces. FIG. 5B depicts embodiment 520 of the Faraday antenna in an actuated state. The distance d and angle α of the deformed loop are limited by the yield strength of the metal used to fabricate the loop. In an alternative embodiment, cantilevers 504 are actuated at a high vibrating frequency to periodically deform or bend towards each other, also resulting in a periodic change in area of the antenna loop.

FIG. 5C depicts a perspective view of a Faraday antenna in an inactive state 540. Similar to the antennas of FIGS. 5A and 5B, the antenna includes cantilevers 544 joined together by element 542. Cantilevers 544 are supported by anchors 548. FIG. 5C also includes electrode 546 which when actuated deforms or bends cantilevers 504. However, the distance d and angle α of the deformed loop are limited by the yield strength of the metal used to fabricate the loop. This limitation is a function of the resonant frequency of the device and may limit the gain of the antenna and reduce the maximum signal-to-noise ratio per unit area. One way to overcome this limitation is illustrated by the antenna of FIG. 5D. Similar to the antenna of FIG. 5C, the antenna includes cantilevers 544 joined together by element 542. However, electrode 566 is smaller than electrode 546 and placed such that it only deforms or bends a portion of cantilevers 504 close to anchors 548 and the remaining portion remains unstressed. This leverage bending of cantilevers 504 may increase angle α and displacement d of element 542. The leverage bending technique also enables higher vibrating frequencies to be used leading to better gain for the antenna.

For the embodiments described with respect to FIGS. 5A-5D, the periodic change in area orientation of the antenna loop results in a periodic change in magnetic flux through the antenna loop. This magnetic flux creates a periodic voltage across the antenna loop according to the Faraday-Lenz law, where the voltage v_{F} generated across the antenna is a negative variation of the magnetic flux Φ, and calculated as:

$${v}_{F} ( t ) = - \frac{d}{d t} Φ ( t )$$

This calculated voltage v_{F} corresponds to the incoming signal received at the antenna at time t. As the antenna loop is periodically actuated at the high vibrating frequency, voltage v_{F} calculated across time corresponds to the incoming signal received at the Faraday antenna. In one embodiment, the vibrating frequency of the Faraday antenna ranges from about 100 kHz to about 100 MHz. In another embodiment, the vibrating frequency of the Faraday antenna ranges from about 100 kHz to about 10 GHz, e.g., when the Faraday antenna is fabricated using a CMOS MEMS-based process. It is desirable for the vibrating frequency to be higher than the bandwidth frequency of the signal to avoid aliasing issues. Faraday antennas may be useful in the field of spatially multiplexed networks. They may also be used in the field of radio-frequency identification (RFID), e.g., to provide compact RFID tags in textile manufacturing, e.g., to track a source of yarn used in textiles.

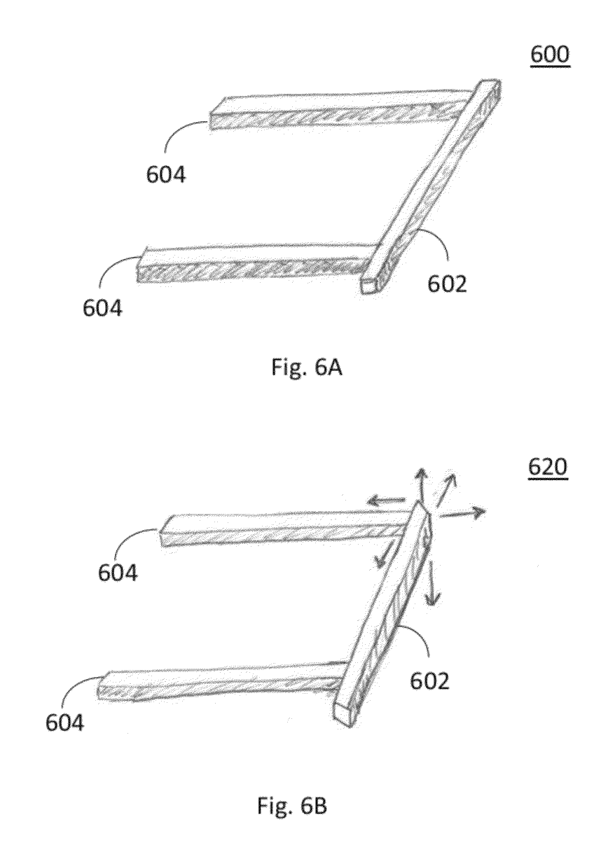

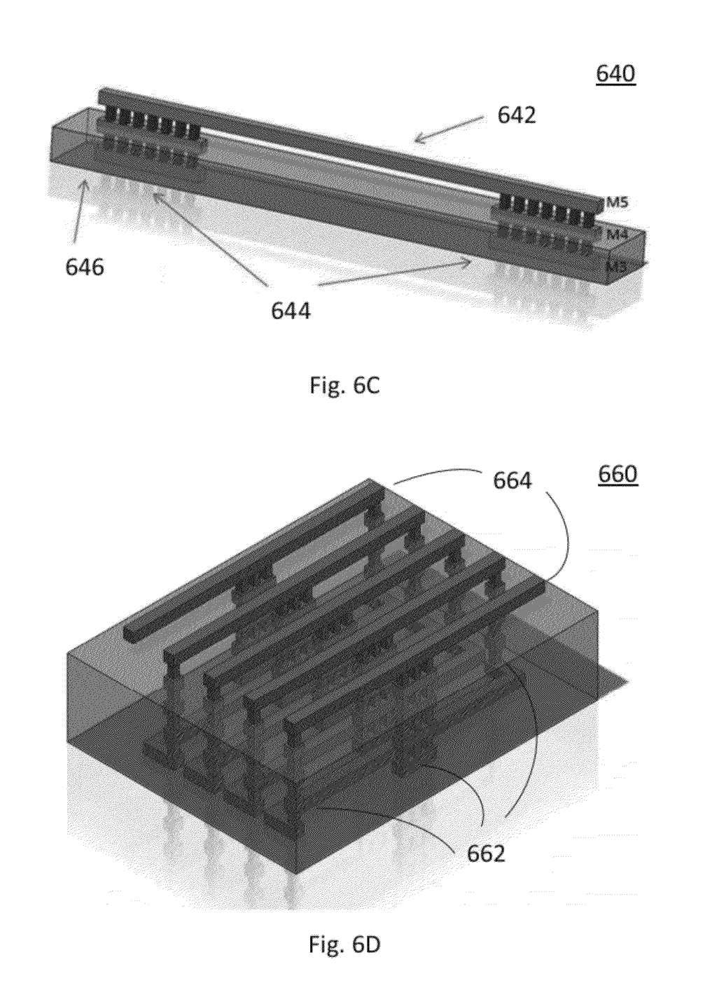

FIG. 6A depicts a diagrammatic view of a Lorentz antenna in an inactive state 600. In the embodiment shown, the Lorentz antenna includes a bridge 602 attached to anchors 604. As evident from the similarity in structure to the Faraday antenna, the Lorentz antenna is a modification of the Faraday antenna. However, instead of deforming the antenna loop, only bridge 602 is periodically deformed or moved at a vibrating frequency. The Lorentz antenna is electrostatically actuated at a high vibrating frequency to periodically move bridge 602 in, e.g., up/down or left/right directions. The actuation may alternatively be due to magnetic, piezoelectric, or thermal forces. FIG. 6B depicts embodiment 620 of the Lorentz antenna in an actuated state. The direction of movement of bridge 602 is dependent on the orientation of the applied actuation. The mechanical movement and the external magnetic field generate a voltage across bridge 602 due to a Lorentz force experienced by bridge 602. As bridge 602 is periodically actuated at the high vibrating frequency, the voltage across the antenna loop calculated across time corresponds to the incoming signal received at the Lorentz antenna. Since only a moving bridge is required, the Lorentz antenna is easier to build than a Faraday antenna. For example, FIG. 6C illustrates an embodiment of a Lorentz antenna fabricated with moving bridge 642 and connected with anchors 644. Anchors 644 are buried in the oxide of Inter Metal Dielectric (IMD) layer 646 to provide support to the Lorentz antenna. The deformation or movement of bridge 602 is limited by the yield strength of the metal used to fabricate bridge 602. In one embodiment, the length of bridge 602 ranges from about 50 um to about 100 um. In order to overcome this limitation, a series of Lorentz antennas may be used. This is illustrated in FIG. 6D where antenna 660 is fabricated with a series of Lorentz antennas 664, each having anchors 662. Such a series of N Lorentz antennas each having a bridge length/behaves as a Lorentz antenna having a bridge length N·l.

In one embodiment, the vibrating frequency of the Lorentz antenna ranges from about 100 kHz to about 100 MHz. In another embodiment, the vibrating frequency of the Lorentz antenna ranges from about 100 kHz to about 10 GHz, e.g., when the Lorentz antenna is fabricated using a CMOS MEMS-based process. It is desirable for the vibrating frequency to be higher than the bandwidth frequency of the signal to avoid aliasing issues. Lorentz antennas may be useful in the field of spatially multiplexed networks. They may also be used in the field of automotive radar and high resolution scanner applications (described above with respect to the Flashing antenna) and radio-frequency identification (RFID) (described above with respect to the Faraday antenna).

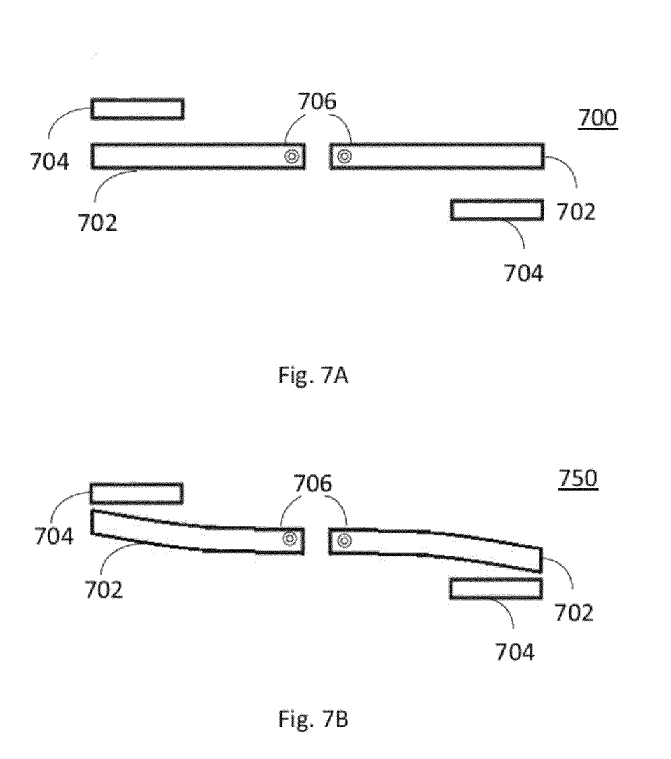

FIG. 7A depicts a diagrammatic view of a linear rotating antenna in an inactive state 700. In the embodiment shown, the linear rotating antenna is observed from the top and includes fixed metal stacks 704 and moveable plates 702. Moveable plates 702 are fixed at one end by anchors 706 but are free to move at their other end. The linear rotating antenna is electrostatically actuated at a high vibrating frequency by periodically applying a voltage to metal stacks 704. The actuation may alternatively be due to magnetic, piezoelectric, or thermal forces. The applied voltage causes movement of moveable plates 702 towards their respective metal stacks 704 in a periodic manner, as shown in FIG. 7B. As the antenna moves in time towards a certain direction, the gain of the antenna in that direction may increase with time. Similarly, as the antenna moves away in time from a certain direction, the gain of the antenna in that direction may decrease with time. In other words, a signal received from a certain direction at the antenna is modulated by the gain associated with that direction at that point in time. If the antenna is operated at an appropriate vibrating frequency, the moveable plates of the antenna can be placed such that each signal coming from a set of directions is modulated with a high gain, while signals from other directions are filtered or attenuated. This approach allows the linear rotating antenna to be highly directive and receive signals only from desired directions. In one embodiment, the linear rotating antenna places signals coming from different directions in different frequency bands. This enables the antenna to detect and distinguish signals from different directions simultaneously.

In one embodiment, the vibrating frequency of the linear rotating antenna ranges from about 100 kHz to about 100 MHz. In another embodiment, the vibrating frequency of the linear rotating antenna ranges from about 100 kHz to about 10 GHz, e.g., when the linear rotating antenna is fabricated using a CMOS MEMS-based process. It may be advantageous to have vibrating frequencies on the order of 1 GHz. For example, cellular networks operate in about 1-2 GHz frequency range. If a incoming signal having a carrier frequency of about 1 GHz is received at a linear rotating antenna having a vibrating frequency of about 1 GHz, upon modulation by the antenna the signal frequency may be centered at DC (i.e., near zero). Communications devices typically include highly selective complex filters, e.g., surface acoustic wave (SAW) or Film Bulk Acoustic Resonator (FBAR) filters, in communication with a mixer, to obtain an incoming signal centered at a DC (near-zero) frequency. However, a linear rotating antenna having a frequency on the order of 1 GHz may eliminate the need for complex filters and/or a mixer in order to obtain the desired incoming signal centered at a DC (near-zero) frequency. Such a linear rotating antenna is also easy tunable for different vibrating frequencies. In some embodiments, the linear rotating antenna is fabricated using a MEMS CMOS process and can support high frequencies not available in typical MEMS devices. This is because the MEMS CMOS process offers a feature size around 0.3 μm as compared to the 1-2 μm feature size offered by typical MEMS processes.

The vibrating frequency of the linear rotating antenna may be subject to certain constraints to enable proper operation. In one embodiment, the vibrating frequency is chosen such that it is higher than the bandwidth frequency of the incoming signal but much lower than the carrier frequency. The carrier frequency is the central frequency of an incoming signal while the bandwidth frequency is the frequency spanning above and below from this central frequency. These constraints eliminate any aliasing problems when receiving the incoming signal and the antenna may be analyzed as if it were a static antenna. In one embodiment, the linear size of the linear rotating antenna is at least on the same order of magnitude as the wavelength of the incoming signal. This constraint enables high directivity in transmission/reception of signals to the linear rotating antenna. In one embodiment, at least two linear rotating antennas are provided and the periodic voltage applied to their respective metal stacks 704 are synchronized such that their respective moveable plates 702 move together in a synchronized manner. Such antennas are referred to as synchronized rotating antennas. The synchronized rotating antennas may provide higher directivity in transmission/reception of signals compared to the linear rotating antenna, even when having electrical sizes smaller than the wavelength of the incoming signal. With linear rotating antennas, the resulting gain or directivity is a linear combination of the directivity of the antennas (in the case of multiple antennas that are switched) or the antenna positions/orientations/shapes at different time intervals (in the case of a single antenna that moves or deforms). Therefore, using elemental antennas (i.e., antennas that are small compared to the wavelength of the incoming signal) that have typically low directivity will result in a linear rotating antenna with low directivity. However, vibrating antennas with high directivity are desirable to implement a spatially multiplexed network as described above. Therefore, linear rotating antennas may to use larger base antennas to provide high directivity and cannot use elemental antennas. One way to overcome this limitation is to instead use elemental antennas in synchronized rotating antennas. This is because when the synchronized rotating antennas move together, they exhibit the same gain at the same time. Their respective gains are multiplied, i.e., the gain is squared, and the signal is modulated according to the squared gain. Elemental antennas exhibiting such a squared gain no longer suffer from directivity limitations and may be used in applications desiring high directivity such as a spatially multiplexed network. Rotating antennas may also be used in the field of automotive radar and high resolution scanner applications (described above with respect to the Flashing antenna).

We now describe process flow steps for fabricating a vibrating antenna via a CMOS MEMS-based process. For example, the vibrating antenna may be fabricated using a CMOS MEMS-based process described in commonly-owned U.S. Patent Application Publication No. 2010/0295138, entitled “Methods and Systems for Fabrication of MEMS CMOS Devices”. However, fabrication processes for a vibrating antenna need not be limited to CMOS MEMS-based processes, and may include MEMS-based processes, NEMS-based processes, and other suitable processes.

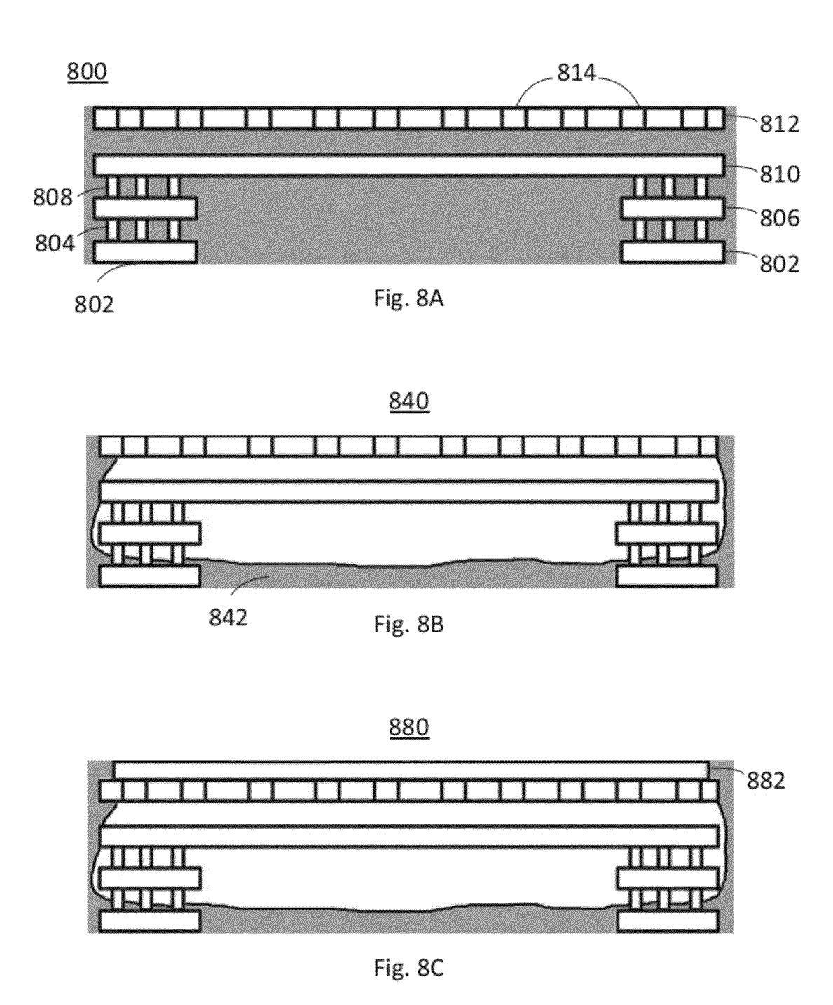

FIG. 8A depicts a cross-section after a first set of process flow steps for fabricating a vibrating antenna, in particular, a Lorentz antenna. The thickness of the layers has been magnified. In one embodiment, the vibrating antenna is fabricated using a standard CMOS process. In one embodiment, the vibrating antenna is fabricated in a cavity formed within interconnection layers of a CMOS chip. In an alternative embodiment, the vibrating antenna is fabricated as a stand-alone MEMS device. Initially a metal layer is deposited. The metal layer can be made from, e.g., AlCu metal alloy. A masking layer is deposited above the metal layer, and then the metal layer is etched using, e.g., dry HF, to form plates 802. An Inter Metal Dielectric (IMD) layer is deposited above plates 802, followed by a masking layer, and then the IMD layer is etched and filled with metal to form spacers or vias 804. In one embodiment, the IMD layer includes a layer of non-doped oxide. Another metal layer is deposited, followed by a masking layer deposited above the metal layer, and then the metal layer is etched using, e.g., dry HF, to form plates 806. Another IMD layer is deposited above plates 806, followed by a masking layer, and then the IMD layer is etched and filled with metal to form spacers or vias 808. Plates 802 and 804 and spacers 806 and 808 together form anchors for the vibrating antenna. A metal layer is deposited on spacers 808 to form bridge 810 of the vibrating antenna. Another IMD layer is deposited on bridge 810, followed by top metal layer 812. A masking layer is deposited on top metal layer 812. Top metal layer 812 is then etched to form through-holes 814. The through-holes can allow passage of etchant, e.g., vapor HF, to etch material below top metal layer 812.

FIGS. 8B and 8C depict cross-sections after a second and a third set of process flow steps, respectively, for fabricating the vibrating antenna. An etchant, e.g., dry HF, is released via through-holes 814 in top metal layer 812. The etchant etches away portions of the IMD layers to release the anchors and bridge of the vibrating antenna, as shown in FIG. 8B. Bottom plates 802 are buried in the remaining oxide 842 of IMD layers to provide support to the vibrating antenna. Finally, metallization layer 882 is deposited on top metal layer 812 to seal the vibrating antenna from the outside environment, as shown in FIG. 8C. In one embodiment, the vibrating antenna is fabricated using MEMS-based, NEMS-based, or MEMS CMOS-based integrated chip technology.

Applicants consider all operable combinations of the embodiments disclosed herein to be patentable subject matter. Those skilled in the art will know or be able to ascertain using no more than routine experimentation, many equivalents to the embodiments and practices described herein. For example, though the vibrating antenna described with respect to FIGS. 8A-8C is a Lorentz antenna, the embodiments and practices may be equally applicable to other vibrating antennas such as Flashing antenna, Faraday antenna, linear rotating antenna, synchronized rotating antenna, or any other suitable vibrating antenna. Accordingly, it will be understood that the systems and methods described herein are not to be limited to the embodiments disclosed herein, but is to be understood from the following claims, which are to be interpreted as broadly as allowed under the law. It should also be noted that, while the following claims are arranged in a particular way such that certain claims depend from other claims, either directly or indirectly, any of the following claims may depend from any other of the following claims, either directly or indirectly to realize any one of the various embodiments described herein.

1. A communications system, comprising:
a plurality of portable communications devices forming a spatially multiplexed network, each communications device including a vibrating antenna, the vibrating antenna configured to receive and transmit in a plurality of directions;
a first communications device of the plurality of communications devices configured to transmit a signal to the plurality of communications devices, wherein transmitting the signal comprises initiating a movement of a first vibrating antenna of the first communications device;
a second communications device of the plurality of communications devices configured to receive the signal and retransmit the signal to the plurality of communications devices, wherein receiving the signal comprises allowing a movement of a second vibrating antenna of the second communications device in response to the signal.

2. The communications system of claim 1, wherein the vibrating antenna includes one of a MEMS-based vibrating antenna, a NEMS-based vibrating antenna, and a CMOS MEMS-based vibrating antenna.

3. The communications system of claim 2, wherein the vibrating antenna is selected from the group consisting of a flashing antenna, a faraday antenna, a lorentz antenna, a linear rotating antenna, and a synchronized rotating antenna.

4. The communications system of claim 1, comprising a base station configured to (i) receive the signal from at least one of the plurality of communications devices, and (ii) send a second signal to at least one of the plurality of communications devices.

5. The communications system of claim 1, wherein the network is a telecommunications network and at least one of the communications devices is a mobile telephone.

6. The communications system of claim 1, wherein a capacity available to each communication device is proportional to the number of communications devices forming the network.

7. The communications system of claim 1, wherein the vibrating antenna is composed of at least one of silicon, carbon nano-tubes, and graphene.

8. The communications system of claim 1, wherein the movement of the first vibrating antenna is initiated at a frequency corresponding to an open or unlicensed wireless frequency.

9. The communications system of claim 1, wherein the movement of the first vibrating antenna is initiated at about 60 GHz or a higher frequency.

10. The communications system of claim 1, wherein the plurality of communications devices are determined to be within a vicinity of the first communications device.

11. A method for providing a communications system comprising:
providing a plurality of portable communications devices forming a spatially multiplexed network, each communications device including a vibrating antenna, the vibrating antenna configured to receive and transmit in a plurality of directions;
transmitting, from a first communications device of the plurality of communications devices, a signal to the plurality of communications devices, wherein transmitting the signal comprises initiating a movement of a first vibrating antenna of the first communications device;
receiving the signal at a second communications device of the plurality of communications devices, wherein receiving the signal comprises allowing a movement of a second vibrating antenna of the second communications device in response to the signal;
retransmitting, form the second communications device, the signal to the plurality of communications devices.

12. An electromagnetic signal emitting and/or receiving device having a minimum operational bandwidth, the device comprising:
at least one antenna for generating an output signal, wherein the antenna is oriented in a first direction and configured to be at least one of periodically deformed, periodically tilted, and periodically oriented in a second direction different from the first direction according to a first periodic movement, the first periodic movement having a first frequency higher than the minimum operational bandwidth.

13. The device of claim 12, wherein the antenna is further configured to be periodically rotated according to the first periodic movement.

14. The device of claim 12, wherein the antenna is further configured to be periodically switched according to the first periodic movement.
